(19) United States
(12) Patent Application Publication
(10) Pub. No.: US 2006/0122358 A1
(43) Pub. Date: Jun. 8, 2006

(54) Imaging on polyurea based films

(75) Inventors: Douglas A. Cahill, Belcher Town, MA (US); Richard S. Himmelwright, Wilbraham, MA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Cold Spring Technology, Inc., Three Rivers, MA (US)

(21) Appl. No.: 11/274,089

(22) Filed: Nov. 16, 2005

Related U.S. Application Data
(60) Provisional application No. 60/627,963, filed on Nov. 16, 2004.

(51) Int. Cl. C08G 18/10

(52) U.S. Cl. 528/64

(57) ABSTRACT

Provided are polyurea/polyurethane based films and coatings which are imaged by a dye sublimation technique, and the method for imaging same.

### CROSS REFERENCE TO RELATED APPLICATION

The present application claims priority to Provisional U.S. Application No. 60/627,963, filed on Nov. 16, 2004, which is incorporated by reference herein in its entirety.

### BACKGROUND OF THE INVENTION

Provided is a general design for polyurea based films and coatings in which a high quality image can be transferred to and permanently embedded into the surface of the polyurea based material. A process for transferring images to the surface of polyurea based films and coatings is also provided.

Polyurea based films and coatings are well known for their use in protecting concrete, steel, wood and many other surfaces. The applications vary widely from water tanks to structural steel in bridges to floor coatings and the like. These polyurea based materials provide very durable surfaces and prevent corrosion. The use of these materials is expanding rapidly.

The durable nature of the polyurea based coatings and films provide an excellent surface for carrying images for signage, advertising and directional information. However, the excellent barrier coating properties and chemical resistance of these polyurea based materials make them difficult to directly image by typical techniques such as ink jet or laser printing. In fact, these polyurea based films and coatings often have anti-graffitti properties and actually reject imaging inks or yield poor adhering images.

It is therefore an object of the present invention to provide a method of imaging such polyureas based coatings and films, as well as provide the successfully imaged coatings and films obtained as a result.

### SUMMARY OF THE INVENTION

Surprisingly, it has been found that polyurea and/or polyurethane based films and coatings can be printed using a dye sublimation printing method. In this printing method, a donor sheet is imaged with sublimable polymer based film ink jet ink and dried. The imaged donor sheet is then placed in contact with the desired surface to be imaged, and heat and pressure are applied. The heat forces the dye to sublime and transfer to the polyurea based film surface. The dyes in the gaseous state penetrate the surface and are fixed permanently to the polyurea based material. Material with the now embedded image can be used in many demanding applications where resistance to abrasion, resistance to water damage and general toughness are required.

### DETAILED DESCRIPTION OF THE PREFERRED EMBODIMENTS

As noted above, the polyurea and/or polyurethane based films and coatings of the present invention are imaged with a dye sublimation printing method. This affords a system in which the high durability polyurea based materials can be combined with high quality images and printing to yield valuable final products.

Polyureas are well known, and are often classified as a heterochain macromolecular compound which contains urea groups in its structure. Polyurethanes are also well known, and include materials that incorporate the carbamate function group as well as other functional groups such as ester, amide ether and urea. Commerical polyureas and polyurethanes are well known, which are used as films and coatings. Any such polyureas and/or polyurethanes can be used and imprinted in accordance with the present invention.

The polyurea and/or polyurethane based films and coatings of the present invention are targeted for the protection of many different surfaces. Materials such as concrete, steel, aluminum, wood and others degrade when exposed to abrasion, humidity and various chemicals. The protective films and coatings of this invention dramatically reduce or eliminate the detrimental effects of exposure to these conditions. In addition to the highly durable properties of protective films and coatings made from polyurea and/or polyurethane based materials, now images can be imparted to these surfaces. Surfaces such as the side of water storage tanks and floors can be printed with high quality images or advertising messages and the like.

In a preferred embodiment, the polyurethane/polyurea protective coating or substrate/surface is produced by reacting an isocyanate with a polyol in the presence of a diamine or triamine. Preferably, the diamine or triamine is aliphatic and of low moleculare weight. The polyol is preferably a polyester polyol, a polyether polyol or an acrylic polyol. The reaction is also preferably run in the presence of a catalyst, e.g., a tin, zirconium or bismuth based catalyst.

The polyurea, polyurethane or polyurea/polyurethane coating to be imaged can be applied to a base material, e.g., a floor or sign, by spraying, brushing, by squeege, or any suitable method. A preferred method involves zero solvent high pressure spray. Once the coating or polymer surface is prepared, a donor sheet imaged with a sublimable polymer based ink is then placed in contact with the polymer surface. Heat and pressure are applied to cause the dye to transfer and image the polymer surface. It has been found that using such a method creates excellent, durable images in the polymer surface.

The following examples are provided to further illustrate the present invention, but are not meant to be limiting.

### EXAMPLES

The coatings described are all two part fluids that are combined during application and are cured to give hard durable surfaces. There is an “A” part containing isocyanate materials and a “B” part containing amines and/or polyols. A catalyst, when required, can be placed in either the “A” or “B” part depending on the catalyst used. The “A” and “B” parts are combined via high pressure impingement mixing, static tube mixing or some other rapid mixing device. Immediately after mixing, the fluids are applied to the desired surface by high pressure spraying, squeegee spreading or some other method. If sheets of this material are desired, they can be manufactured by casting the fluid after mixing onto a carrier release sheet and then allowed to cure into final high strength films. This can be accomplished on specially designed coating lines similar to those used in the manufacture of photographic films.

The same isocyanate “A” part was used for all examples and is prepared as follows:

| | % by Weight in |
|---|---|
| | Final Coating |
| “A” part for Examples 1-4 | |
| Isocyanate Trimer | 40.0 |
| Isocyanate Dimer | 9.0 |
| Zirconium catalyst | 2.0 |
| Example No. 1 “B” part | |
| 1,3-Bis-Aminomethyl Cyclohexane | 8.0 |
| Polyether polyol | 20.0 |
| Polyester polyol 1 | 10.5 |
| Polyester polyol 2 | 10.5 |
| Example No. 2 “B” part | |
| Methanediamine | 5.0 |
| Polyether polyol | 21.0 |
| Polyester polyol 1 | 11.5 |
| Polyester polyol 2 | 11.5 |
| Example No. 3 “B” part | |
| Polyoxypropylenetriamine | 5.0 |
| Polyether polyol | 21.0 |
| Polyester polyol 1 | 11.5 |
| Polyester polyol 2 | 11.5 |
| Example No. 4 “B” part | |
| 2-methylpentamethylenediamine | 5.0 |
| Polyether polyol | 21.0 |
| Polyester polyol 1 | 11.5 |
| Polyester polyol 2 | 11.5 |

The “A” and “B” part fluids were combined via a high pressure mixing unit such as the Glas-Craft MIX with a Gussmer Probler mixing gun. The final coating thickness in each case was about 20 mil to 40 mil.

The films generated in the examples were then imaged using the following procedure. A donor sheet was prepared by ink jet imaging in which sublimable inks obtained from Sawgrass Technologies were applied to a donor sheet. The donor sheet was then placed in contact with the polyurea/polyurethane based films and heat and pressure applied. Specifically, a standard heat transfer press was used to transfer the images with settings of 400° F., 40 psi and 20 to 40 seconds of application time. The sheets were removed from the press, allowed to cool to near room temperature, and the donor sheet was peeled off to reveal the fixed image. All four films were successfully imaged.

While the preferred embodiments of the invention have been disclosed in detail, other embodiments within the described invention obvious to those skilled in the art are considered to be part of the present invention and are intended to be including in the claims below.

What is claimed is:

1. Imaging a polyurea, polyurethane or polyurea/polyurethane polymer surface by dye sublimation.

2. The imaging process of claim 1, wherein the polymer surface is a polyurea based film or coating.

3. The imaging process of claim 2, wherein the polymer surface is a coating on a substrate.

4. The imaging process of claim 2, wherein the polymer surface is a polyurea, polyurethane or polyurea/polyurethane polymer sheet.

5. The imaging process of claim 3, wherein the polymer based material was applied via spraying, brushing or squeegeeing prior to the imaging by dye sublimation.

6. The imaging process of claim 3, wherein the substrate is a floor or sign.

7. An imaged aliphatic polyurethane/polyurea protective coating produced by reacting an isocyanate with a polyol in the presence of a low molecular weight aliphatic diamine or triamine and a catalyst followed by application of an image to that coating by dye sublimation printing.

8. The imaged coating of claim 7, wherein the isocyanate is a dimer or trimer; the polyol is a polyester polyol, a polyether polyol or an acrylic polyol; the diamine is 1,3-BAC; and the catalyst is tin, zirconium or bismuth based.

9. The imaged coating of claim 7, wherein the low molecular weight diamine is present in the range of from 0.5% to 20% by weight of total solids.

10. The imaged coating of claim 7, wherein the coating is applied by zero solvent high pressure spray.

11. The imaged coating of claim 7, wherein the coating is of a thickness ranging from 0.1 mil to 100 mil (2.5 μM to 2500 μM).

12. The imaged coating of claim 7, wherein the low molecular weight aliphatic amine is polyoxypropylenetriamine, methanediamine, 2-methylpentamethylenediamine, or Clearlink 1000.
